(19) United States
(12) Patent Application Publication
(10) Pub. No.: US 2013/0119920 A1
(43) Pub. Date: May 16, 2013

(54) ELECTRIC VEHICLE CHARGING SYSTEM AND CHARGING MANAGEMENT METHOD THEREOF

(71) Applicant: Industrial Technology Research Institute, Hsinchu (TW)

(72) Inventors: Yu-Ching Hsu, Hsinchu County (TW); Chai-Hien Gan, Hsinchu City (TW); Yung-Chun Lin, Hsinchu County (TW)

(73) Assignee: INDUSTRIAL TECHNOLOGY RESEARCH INSTITUTE, Hsinchu (TW)

(21) Appl. No.: 13/670,371

(22) Filed: Nov. 6, 2012

(30) Foreign Application Priority Data
Nov. 16, 2011 (TW) 100141752

(51) Int. Cl. H02J 7/00

(52) U.S. Cl. 320/106; 320/109; 320/157

(57) ABSTRACT

An exemplary embodiment provides a charging system including a management device and a plurality of charging devices. The management device includes a scheduling control module and a charging host. The scheduling control module executes dynamic scheduling according to a residence time and a charging time, and re-executes the dynamic scheduling according to a queue-jumping request. The charging host calculates the charging time according to battery information, and charges a plurality of electric vehicles according to the dynamic scheduling. The charging devices are coupled to the management device and connected to the electric vehicles, wherein each of the charging devices includes an input interface and a charging plug. The input interface receives the residence time and a power demand. The charging plug is connected to one of the electric vehicles to receive the battery information, and charges the connected electric vehicle.

### CROSS REFERENCE TO RELATED APPLICATIONS

The present application is based on, and claims priority from, Taiwan (International) Application Serial Number 100141752, filed on Nov. 16, 2011, the disclosure of which is hereby incorporated by reference herein in its entirety.

### BACKGROUND

1. Field

The exemplary embodiments relate to a charging system and a charging management method of electric vehicles, and in particular relates to a charging management method for electric vehicles with a multiple process.

2. Description of the Related Art

Electric vehicles are alternatives to traditional cars. Some of the electric vehicles implementations are better than traditional vehicles using fuel. Different applications and designs of electric vehicles may be advantageous. For instance, exhaust pollution may be reduced, power performance may be enhanced, reliability may be improved, maintain requirements may be reduced, and dependence on the limited supply of conventional fuel may be lessened. Electric vehicles and its innovations have become one of many types of green-energy technologies. The goal of electric vehicles is to reduce greenhouse gases, re-use or save the energy, and adopt renewable energy technologies, such as recharging batteries or fuel cells by braking power, solar or other green energy means. The battery system is one of the main power sources for electric vehicles, and has been used in many electric vehicle products, such as Chevrolet Volt® ‘Telsa Roadster®’ Nissan Leaf® etc.

The battery system of electric vehicles needs to be frequently recharged. However, the different battery systems may have different charging requirements and different considerations for battery cell design, material, and operating conditions. In addition, different charging devices or charging stations may provide different charging conditions which affect the way of recharging or receiving power of the battery systems. Vehicle owners may want to keep track of the recharging process, understand payment methods, and realize other information about the recharging process.

The present charging devices, charging stations and electric vehicles generally lack an appropriate system/method to control or understand the procedure of recharging/billing or other information about recharging. Due to the lack of a suitable system/method, billing of recharging processes may be incorrect, opaque and unreliable, and cause problems with billing errors. Therefore, an ideal system/method for a battery system having monitoring or controlling technology is in need.

### BRIEF SUMMARY

A detailed description is given in the following embodiments with reference to the accompanying drawings.

An exemplary embodiment provides a charging system including a management device and a plurality of charging devices. The management device includes a scheduling control module and a charging host. The scheduling control module executes dynamic scheduling according to a residence time and a charging time, and re-executes the dynamic scheduling according to a queue-jumping request. The charging host calculates the charging time according to battery information, and charges a plurality of electric vehicles according to the dynamic scheduling. The charging devices are coupled to the management device and connected to the electric vehicles, wherein each of the charging devices includes an input interface and a charging plug. The input interface receives the residence time and a power demand. The charging plug is connected to one of the electric vehicles to receive the battery information, and charges the connected electric vehicle.

Another exemplary embodiment provides a charging management method for electric vehicles. The charging management method for electric vehicles is applied to a plurality of charging systems of an electric vehicle management system, and each of the charging system charges a plurality of electric vehicles. In the charging management method for electric vehicles, battery information, a residence time, and a power demand are received from a first electric vehicle of the electric vehicles when the first electric vehicle connects to a charging plug, and a required charging time is calculated according to the battery information and the power demand. When the required charging time is less than the residence time, a charging process is executed. Finally, a billing operation is executed according to the time period of the connection between the first electric vehicle and the charging system, the queue-jumping request, and the dynamic scheduling, when the first electric vehicle and the charging system are separated. Furthermore, the charging process includes: executing dynamic scheduling according to the residence time and the required charging time; re-executing the dynamic scheduling according to a queue-jumping request when the queue-jumping request is received; and charging the first electric vehicle according to the dynamic scheduling.

Additionally, another exemplary embodiment provides another charging management method for electric vehicles. In the method, data of an electric vehicle connected to a first charging system is sent to a second charging system, wherein the data includes identification information, a charging start time, a residence time, battery information, and a power demand of the electric vehicle. Next, whether the second charging system has met the power demand in the residence time is calculated according to the data, and a result is produced for sending to the first charging system. When the result represents that the second charging system has met the power demand in the residence time, an appointment request is sent to the second charging system by the first charging system, wherein the appointment request includes identification information and an appointment certificate of the electric vehicle, and the appointment certificate includes identification information, an expected residence time, and an expected power demand of the electric vehicle. When the second charging system receives the appointment request, an appointment confirmation is sent to the first charging system from the second charging system, wherein the appointment confirmation includes identification information and an appointment certificate of the second charging system.

Furthermore, the other exemplary embodiment provides the other charging management method for electric vehicles. In the method, data is received from an electric vehicle, wherein the data includes identification information, a payment certificate, a charging start time, a residence time, battery information, and a power demand of the electric vehicle. Next, whether the charging system has met the power demand in the residence time is calculated according to the data, and a result is produced for sending to the electric vehicle. When the result represents that the charging system has met the power demand in the residence time, an appointment request of the electric vehicle is received, wherein the appointment request includes the identification information and the payment certificate. Finally, a certification process is executed according to the identification information and the payment certificate, and an appointment confirmation is sent to the electric vehicle, wherein the appointment confirmation includes identification information of the charging system.

### BRIEF DESCRIPTION OF THE DRAWINGS

The exemplary embodiments can be more fully understood by reading the subsequent detailed description and examples with references made to the accompanying drawings, wherein:

FIG. 1 is a schematic diagram illustrating an electric vehicle management system according to an exemplary embodiment;

FIG. 2 is a schematic diagram illustrating a charging system according to an exemplary embodiment;

FIG. 3 is a schematic diagram illustrating a scheduling control module according to an exemplary embodiment;

FIG. 4 is a flowchart of a charging management method for electric vehicles according to an exemplary embodiment; and

FIGS. 5-16 are signal flowcharts of a plurality of charging management methods for electric vehicles according to exemplary embodiments.

### DETAILED DESCRIPTION

The following description is of the best-contemplated mode of carrying out the invention. This description is made for the purpose of illustrating the general principles of the invention and should not be taken in a limiting sense. The scope of the invention is best determined by reference to the appended claims.

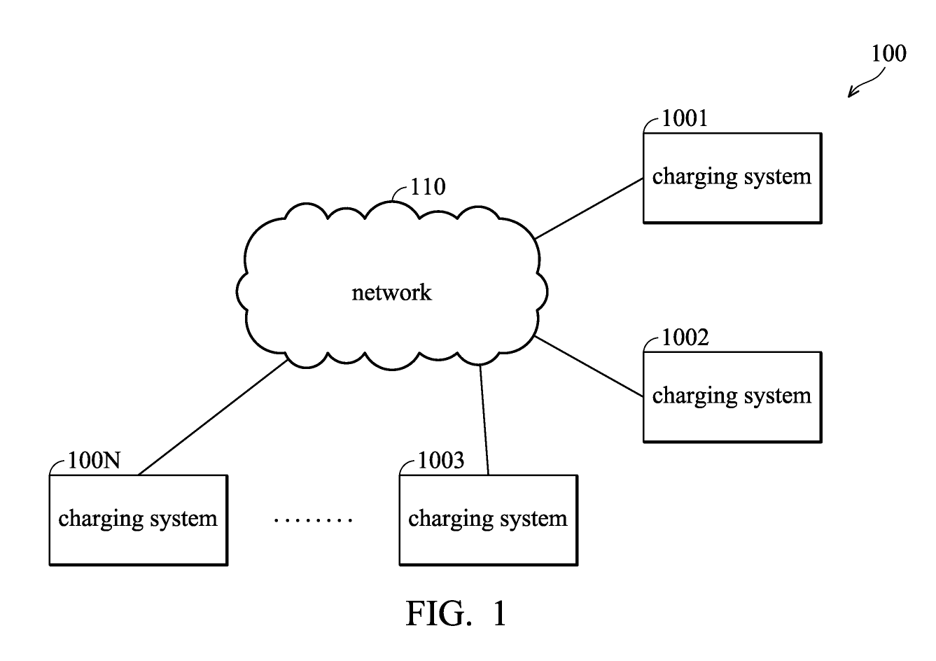

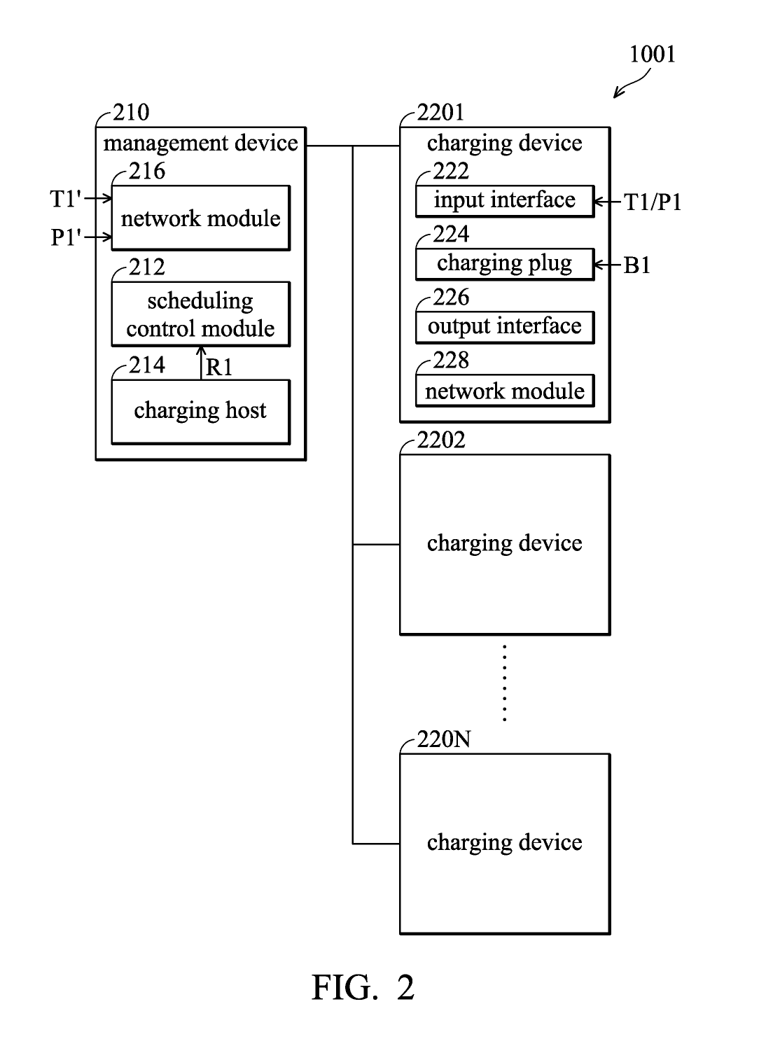

FIG. 1 is a schematic diagram illustrating an electric vehicle management system according to an exemplary embodiment. The electric vehicle management system 100 includes a plurality of charging systems 1001-100N. The charging systems 1001-100N communicate to each other through a network 110, wherein the network 110 can be the Internet, a 3G network, or a 2G network, etc. The structure of the charging systems 1001-100N are the same, and for details, reference may be made to the description of the charging system 1001 in FIG. 2.

FIG. 2 is a schematic diagram illustrating a charging system according to an exemplary embodiment. The charging system 1001 includes a management device 210 and a plurality of charging devices 2201-220N. Each of the charging devices 2201-220N is coupled to the management device 210, and used for connection to an electric vehicle. Each of the charging devices 2201-220N includes an input interface 222, a charging plug 224, an output interface 226, and a network module 228 respectively. The input interface 222 receives a residence time T1 and a power demand P1 from users, wherein the residence time T1 represents how long the user expects to reside their electric vehicle in the charging system 1001, and the power demand P1 represents how much power the user expects the electric vehicle to be charged. In another embodiment, the charging system 1001 calculates the power demand P1 according to the distant or the destination that the user expects to drive/go. For example, the power demand P1 can be a percentage of the battery power of the electric vehicle. The charging plug 224 is used for connection to the electric vehicle, receiving battery information B1 from the connected electric vehicle, and charging the connected electric vehicle. The output interface 226 displays the usage of the charging host 214, the calculation of fees, and a variety of information, but, it is not limited thereto. The network module 228 executes a certification service of payment process and exchanges the contact information of users. In addition, the network module 228 communicates with the management device 210 to exchange the information of the input interface 222 and the output interface 226. For example, the network module 228 can be an NFC RFID (Near Field Communication Radio Frequency IDentification) or an RFID reader (Radio Frequency Identification Reader) to authenticate the tag of users.

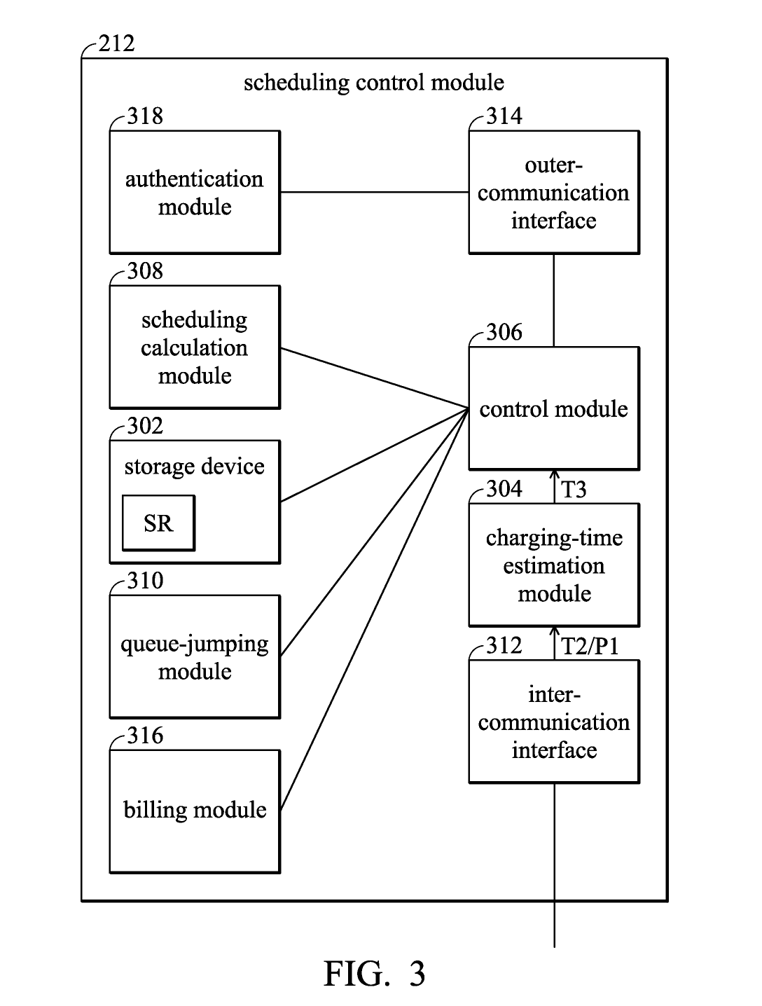

The management device 210 receives the information from the charging devices 2201-220N, and controls the charging devices 2201-220N to charge the connected electric vehicles respectively. The management device 210 includes a scheduling control module 212, a charging host 214, and a network module 216. The scheduling control module 212 executes dynamic scheduling according to the residence time T1 and the charging time T2, and re-executes the dynamic scheduling according to a queue-jumping request of users. For detail, reference can be made to FIG. 3. For example, if a user decides to shorten the residence time T1 while the electric vehicle is being charged, but the charging time arranged by the dynamic scheduling is more than the shortened residence time, the scheduling control module 212 can evaluate the situation and produce a queue-jumping request to let the electric vehicle finish charging in the shortened residence time. In another embodiment, when the charging system 1001 can not finish charging the electric vehicle during the residence time T1, the scheduling control module 212 can evaluate the situation and produce a queue-jumping request to have the charging of the electric vehicle completed in the residence time T1.

The charging host 214 calculates the charging time T2 according to battery information B1, charges a plurality of electric vehicles connected with the charging devices 2201-220N according to the dynamic scheduling, and sends an execution result R1 to the scheduling control module 212, wherein the execution result R1 includes the present charging situation of the connected electric vehicles, etc. For example, the scheduling control module 212 can receive the achieved percentage of the scheduled charging progress according to the execution result R1. In the present embodiment, the charging time T2 represents the charging rate when the charging system 1001 charges the electric vehicle or the requested time that the charging system 1001 needs to finish charging the electric vehicle, according to the battery of the electric vehicle. The battery information B1 includes the battery type and the remaining power of the connected electric vehicle.

The network module 216 sends charging related events occurring in the scheduling control module to a handheld device of users, and receives information form the handheld device. The handheld device can be a cell phone, a tablet, or a notebook, but it is not limited thereto. Additionally, the network module 216 of the management device 210 communicates with the network module 228 of the charging devices 2201-220N by cable or wireless network. It should be noted that the network module 228 and the network module 216 can be combined in a network module of the management device 210 or the charging devices 2201-220N, and the management device 210 and the charging devices 2201-220N can communicate by the other communication circuit. In another embodiment, the scheduling control module 212 re-executes the dynamic scheduling according to the adjusted residence time T1′ and/or the adjusted power demand P1′ when the network module 216 receives the adjusted residence time T1′ and/or the adjusted power demand P1′ from the handheld device of users. It should be noted that the user can input the adjusted residence time T1′ and/or the adjusted power demand P1′ by the other devices, such as the input interface 222 or the network module 228, but it is not limited thereto.

FIG. 3 is a schematic diagram illustrating a scheduling control module according to an exemplary embodiment. The scheduling control module 212 includes an authentication module 318, a scheduling calculation module 308, a storage device 302, a queue-jumping module 310, a billing module 316, an outer-communication interface 314, a control module 306, a charging-time estimation module 304, and an inter-communication interface 312. The storage device 302 stores a current scheduling result SR according to the dynamic scheduling, wherein a current scheduling result SR includes the charging plans of at least one connected electric vehicles scheduled by the dynamic scheduling. For example, when the charging system 1001 is connected and charging with three electric vehicles, the storage device 302 has the current scheduling result SR of the three connected electric vehicles, wherein the current scheduling result SR includes a charging start/stop time (that is charging plan) and the residence time T1 of the three connected electric vehicles respectively.

The charging-time estimation module 304 calculates a required charging time T3 according to the charging time T2 and a power demand P1, wherein the required charging time T3 represents the shortest time that the charging system 1001 can make the power of the electric vehicle reach the power demand P1 by charging. It should be noted that in another embodiment, the charging system 1001 calculates the required charging time T3 without the power demand P1. For example, the charging-time estimation module 304 can predetermine that the power of the electric vehicle needs to be 100%, therefore the charging system 1001 can calculate the required charging time T3 without the power demand P1.

The control module 306 determines whether the electric vehicle needs to jump the queue of the dynamic scheduling according to the residence time T1, the required charging time T3, and the current scheduling result SR. For example, the control module 306 determines that the electric vehicles need to jump the queue of the dynamic scheduling when the current scheduling result SR shows that the electric vehicle can not be charged to the power demand P1 in the residence time T1. On the other hand, the control module 306 determines that the electric vehicles do not need to jump the queue of the dynamic scheduling when the current scheduling result SR shows that the electric vehicle can be charged to the power demand P1 in the residence time T1.

When the control module 306 determines that the electric vehicle does not need to jump the queue, the scheduling calculation module 308 executes a scheduling calculation according to the required charging time T3, the residence time T1, and the current scheduling result SR, and updates the current scheduling result SR of the storage device 302 according to the result of the scheduling calculation.

The queue-jumping module 310 determines whether the current scheduling result SR has a time point which is allowed to jump the queue when the electric vehicles need to jump the queue of the dynamic scheduling. When the current scheduling result has the time point, the queue-jumping module 310 produces a queue-jumping request, executes a queue-jumping calculation according to the time point, the required charging time T3, the residence time T1, and the current scheduling result SR, and updates the current scheduling result SR of the storage device 302 according to the result of scheduling calculation. For example, the queue-jumping module 310 determines whether the charging plan of one of three electric vehicles can be delayed and charge the electric vehicle in the residence time when the current scheduling result SR includes the charging plan and the residence time T1 of the three electric vehicles respectively. If the charging plan of one of the three electric vehicles can be delayed and finished in the required charging time T3, the current scheduling result SR has a time point which is allowed to jump the queue. In another embodiment, the output interface 226 displays the other charging system(s) 1002-100N with a lower loading than the charging system 1001 when the current scheduling result does not have the time point. It should be noted that all the algorithms mentioned are not limited thereto.

The inter-communication interface 312 communicates with the charging host 214, and the outer-communication interface 314 communicates with the network module 216. The billing module 316 executes a billing operation according to the time period of the connection between the electric vehicle and the charging system, the queue-jumping request, and the dynamic scheduling, when the electric vehicle and the charging system are separated. The authentication module 318 certifies a smart card or a credit card according to the billing operation to charge the user. It should be noted that the embodiments can charge the user by other ways, such as a coin charging device, etc.

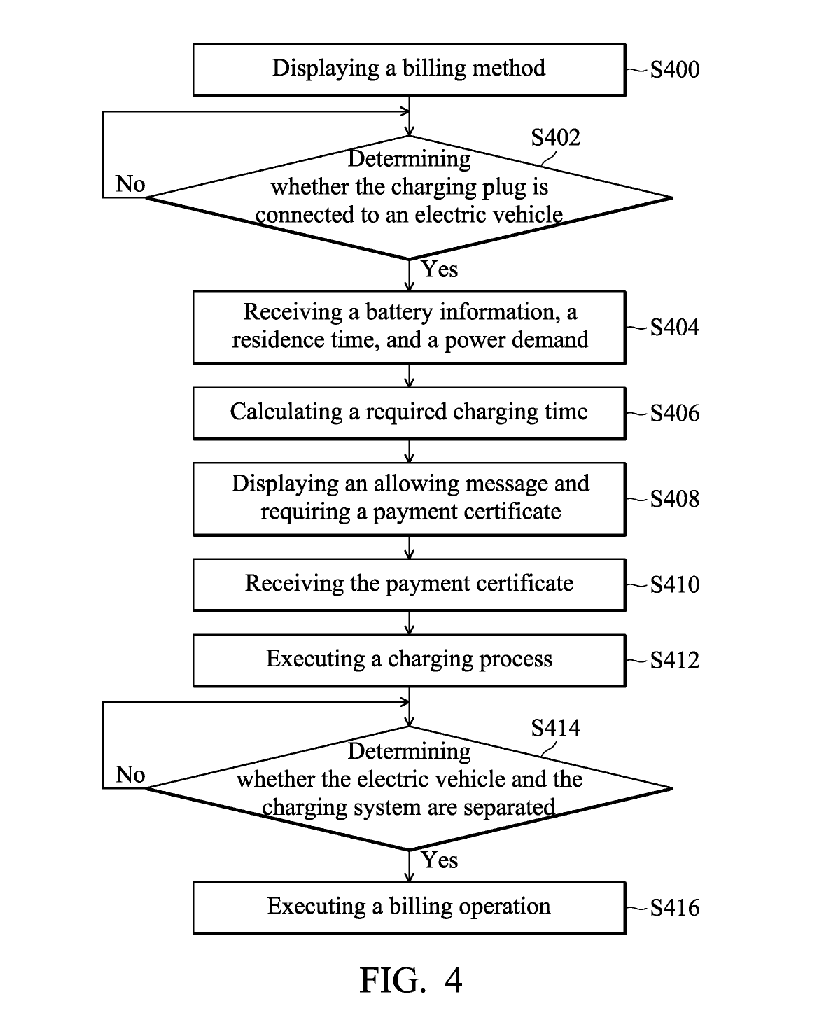

FIG. 4 is a flowchart of a charging management method for electric vehicles according to an exemplary embodiment. The charging management method for electric vehicles is applied to a plurality of charging systems 1001-100N of the electric vehicle management system 100, wherein each of the charging systems 1001-100N charges a plurality of electric vehicles. The following description is takes the charging system 1001 as an example, and the process starts at the step S400.

In the step S400, the charging system 1001 displays a billing method by the output interface 226.

Next, in the step S402, the charging system 1001 determines whether the charging plug 224 is connected to an electric vehicle. When the charging plug 224 is connected to the electric vehicle, the process goes to step S404; otherwise, the charging system 1001 continues to determine whether the charging plug 224 is connected to an electric vehicle.

In the step S404, the charging system 1001 receives battery information B1, a residence time T1, and a power demand P1 from the connected electric vehicle.

Next, in the step S406, the charging-time estimation module 304 calculates a required charging time T3 according to the battery information B1 and the power demand P1.

Next, in the step S408, the output interface 226 displays an allowing message and requires a payment certificate corresponding to charging when a required charging time T3 is less than the residence time T1. For example, the payment certificate can be an NFC RFID (Near Field Communication Radio Frequency IDentification) or an RFID tag (Radio Frequency Identification Tag), and the network module 228 can be an NFC RFID (Near Field Communication Radio Frequency IDentification) or an RFID reader (Radio Frequency Identification Reader) to certificate the tag of users.

Next, in the step S410, the network module 228 receives the payment certificate corresponding to charging.

Next, in the step S412, the charging system 1001 executes a charging process. In the charging process, a scheduling calculation module 308 executes dynamic scheduling according to the residence time T1 and the required charging time T3, such that the charging host 214 charges the electric vehicle according to the dynamic scheduling. The queue-jumping module 310 re-executes the dynamic scheduling according to the queue-jumping request when the queue-jumping request is received, such that the charging host 214 charges electric vehicles according to the new dynamic scheduling.

Next, in the step S414, the charging system 1001 determines (assesses) whether the electric vehicle and the charging system 1001 are separated. When the electric vehicle and the charging system 1001 are separated, the process goes to step S416; otherwise, the charging system 1001 continuous to determines whether the electric vehicle and the charging system 1001 are separated.

In the step S416, the billing module 316 executes a billing operation according to the time period of the connection between the electric vehicle and the charging system 1001, the queue-jumping request, and the dynamic scheduling. Furthermore, the output interface 226 displays the result of the billing operation. The process ends at the step S416.

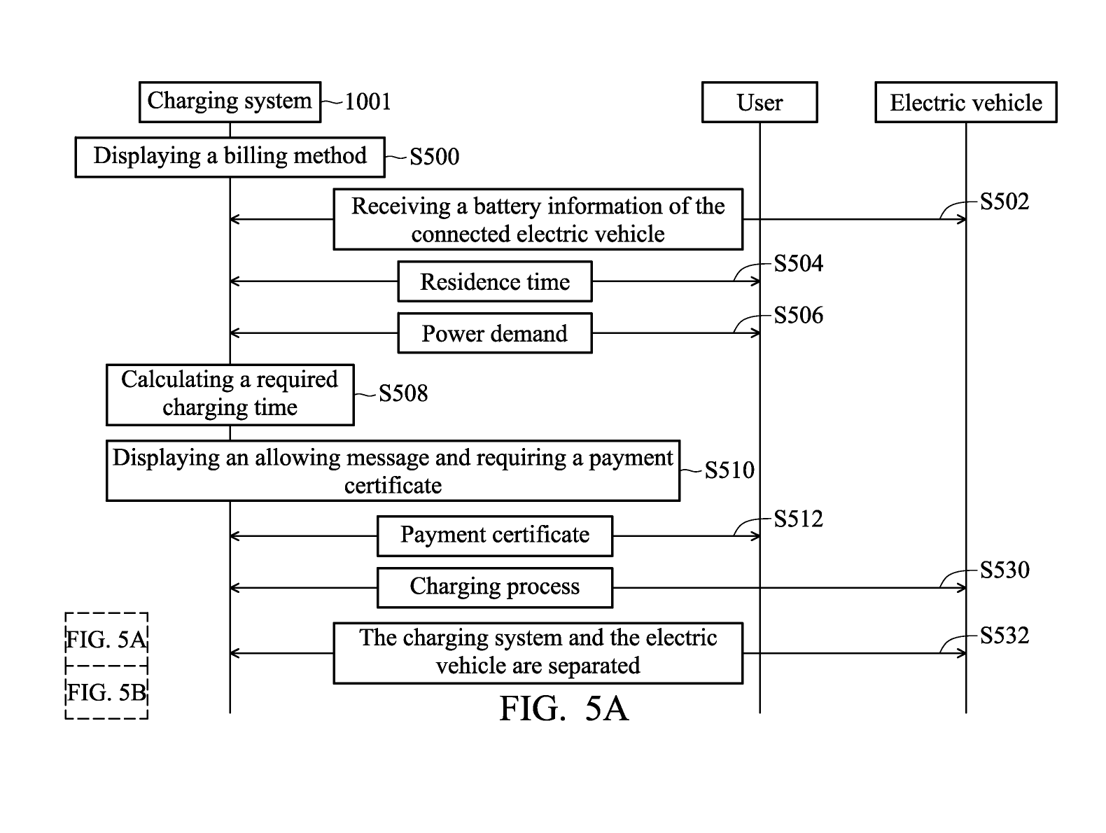

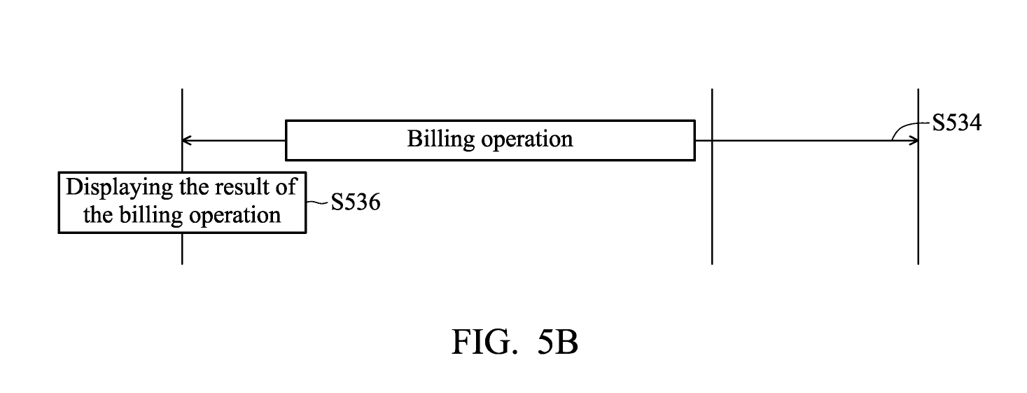

FIG. 5 is a signal flowchart of a charging management method for electric vehicles according to an exemplary embodiment. The charging management method for electric vehicles is applied to a plurality of charging systems 1001-100N of the electric vehicle management system 100. In the present embodiment, the charging system 1001 can finish charging the electric vehicle in the residence time T1, and will not notice a user who jumps into the queue as a result of the re-scheduling according to the queue-jumping request. The following description takes the charging system 1001 as an example, and the process starts at the step S500.

In the step S500, the charging system 1001 displays a billing method by an output interface 226, wherein the billing method includes parking fees and electricity charges, but it is not limited thereto.

Next, in the step S502, when the charging system 1001 connects to an electric vehicle by the charging plug 224, the charging system 1001 receives battery information B1 of the connected electric vehicle. In the step S504, the charging system 1001 receives a residence time T1 entered by users through the input interface 222 or the network module 228. In the step S506, the charging system 1001 receives a power demand P1 entered by users through the input interface 222 or the network module 228.

Next, in the step S508, the charging-time estimation module 304 of the charging system 1001 calculates a required charging time T3 according to the battery information B1 and the power demand P1. In the step S510, the output interface 226 displays an allowing message when the required charging time T3 is less than the residence time T1.

Next, in the step S512, the user receives the requirement of a payment certificate, and the user sends the payment certificate to the charging system 1001 by the network module 228.

Next, in the step S530, the charging system 1001 executes a charging process to the electric vehicle when the charging system 1001 receives the payment certificate. In the charging process, the scheduling calculation module 308 executes dynamic scheduling according to the residence time T1 and the required charging time T3, such that the charging host 214 charges the electric vehicle according to the dynamic scheduling. The queue-jumping module 310 re-executes the dynamic scheduling according to the queue-jumping request when the queue-jumping request is received, such that the charging host 214 charges electric vehicles according to the new dynamic scheduling.

Next, in the step S532, the charging system 1001 and the electric vehicle are separated. In the step S534, the billing module 316 executes a billing operation according to the time period of the connection between the electric vehicle and the charging system 1001, the queue-jumping request, and the dynamic scheduling to calculate the fees of the charging process. Finally, in the step S536, the output interface 226 displays the result of the billing operation. The process ends at the step S536.

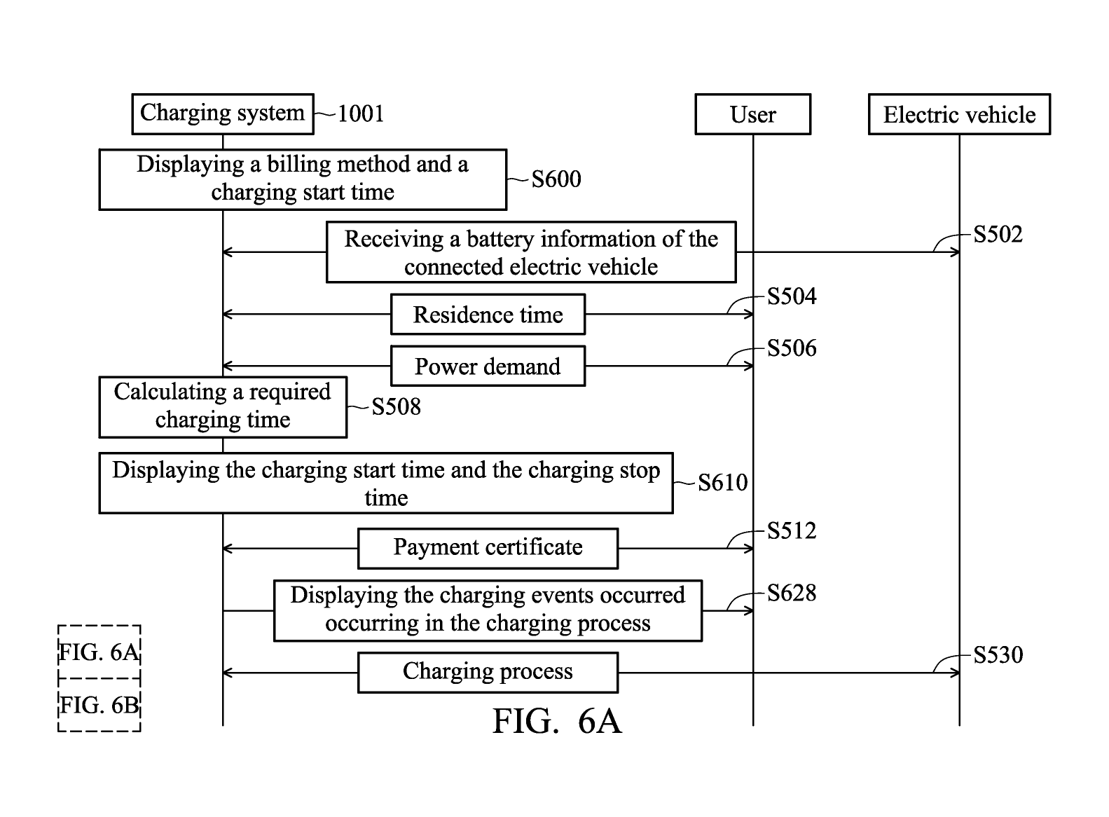

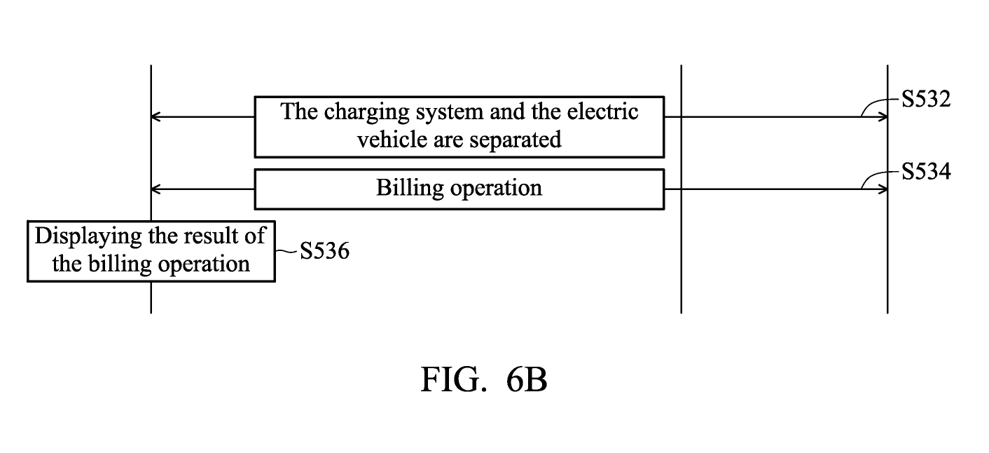

FIG. 6 is a signal flowchart of a charging management method for electric vehicles according to an exemplary embodiment. The charging management method for electric vehicles is applied to a plurality of charging systems 1001-100N of the electric vehicle management system 100. In this embodiment, the charging system 1001 successfully charges the electric vehicle, and notices a user who jumped into the queue as a result of the re-scheduling according to the queue-jumping request. The process starts at the step S600. It should be noted that the steps S600, S610, and S628 are different from the embodiment of FIG. 5, but the steps S502-S508, S512, and S530-S536 of this embodiment are similar with the embodiment of FIG. 5. Therefore, reference can be made to FIG. 5 for the details of the steps S502-S508, S512, and S530-S536.

In the step S600, the charging system 1001 displays a billing method and a charging start time according to the current scheduling result SR by the output interface 226, wherein the charging start time represents when the charging system can start to charge the electric vehicle.

In the step S610, when the required charging time T3 is less than the residence time T1, the charging start time and the charging stop time are displayed, wherein the charging stop time represents when the charging system 1001 can finish charging the electric vehicle.

In the step S628, the charging system 1001 displays the charging events occurring in the charging process by an output interface 226. For example, the charging system 1001 will notice the user by the output interface 226 when the charging sequence of the electric vehicle jumps the queue in the charging process. In another embodiment, the charging system 1001 can send the charging events occurring in the charging process to the handheld device of the user by the network module 216 to notice the user.

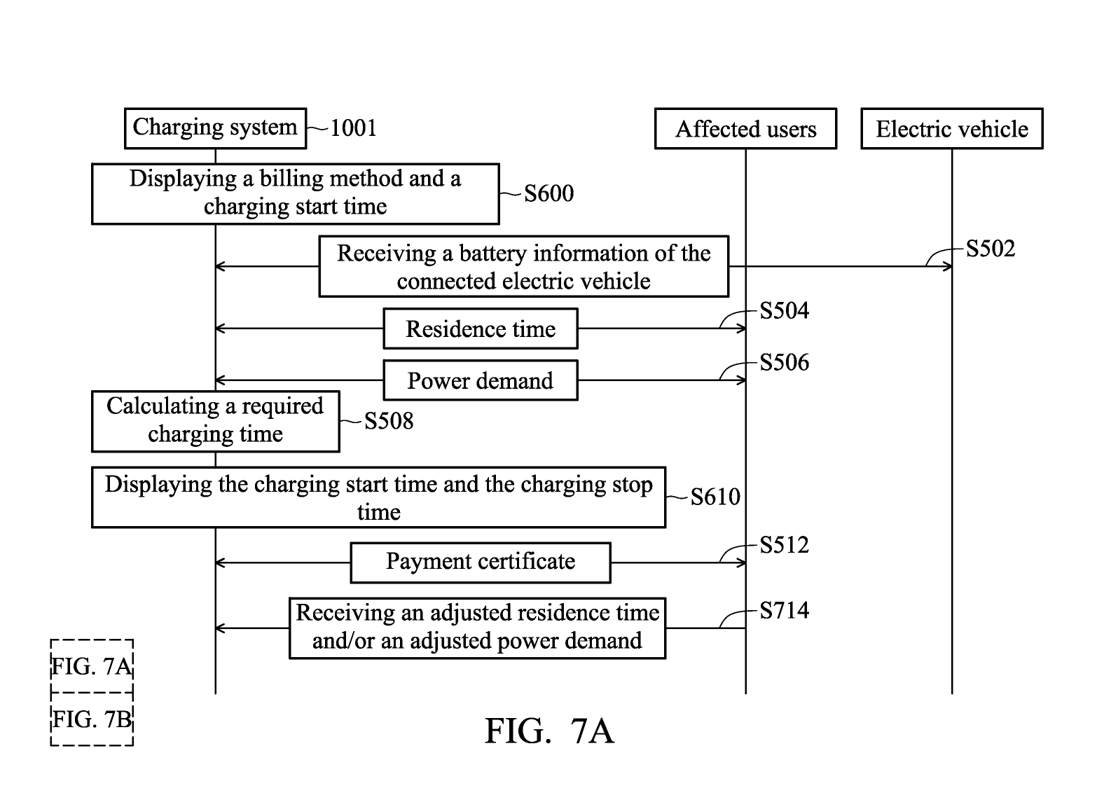

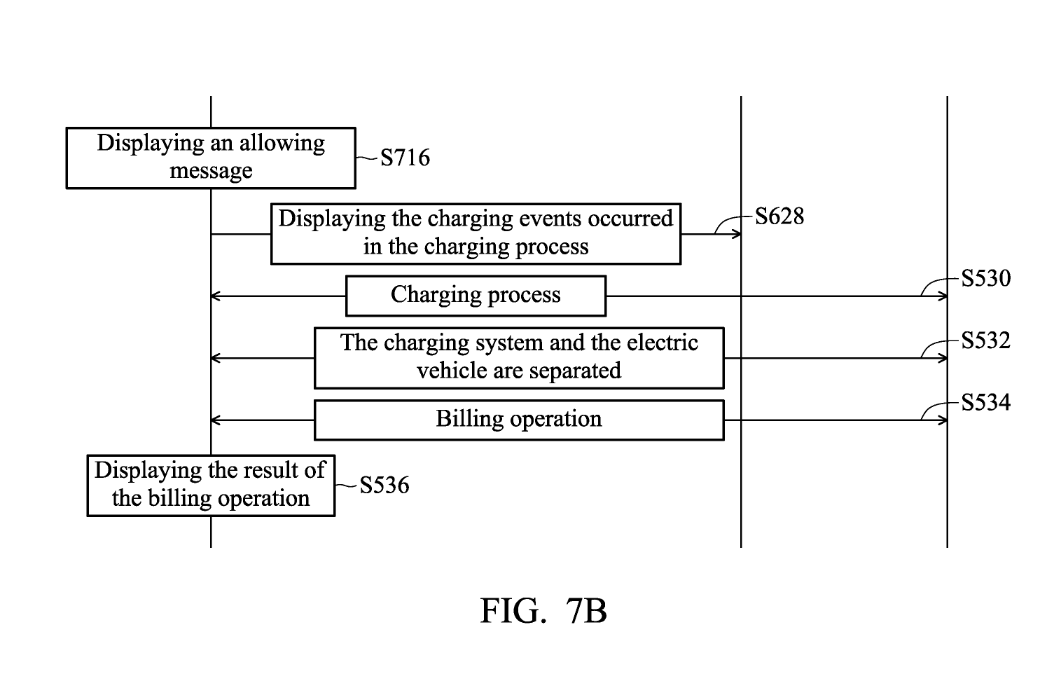

FIGS. 7A-7B are a signal flowchart of a charging management method for electric vehicles according to exemplary embodiments. The charging management method for electric vehicles is applied to a plurality of charging systems 1001-100N of the electric vehicle management system 100. In this embodiment, the charging system 1001 re-executes the dynamic scheduling according to the adjusted residence time T1′ and/or the adjusted power demand P1′ during/before the charging process, and notices the user from the result of the re-executed dynamic scheduling. The process starts at the step S600. It should be noted that the steps S714 and S716 are different from the embodiment of FIG. 6, but the steps S600, S502-S508, S610, S512, S628, and S530-S536 of this embodiment are similar with the embodiment of FIG. 6. Therefore, reference may be made to FIG. 6 for the details of the steps S600, S502-S508, S610, S512, S628, and S530-S536.

In the step S714, the user adjusts the residence time T1 and/or the power demand P1 entered at the steps S504-S506. Therefore, the charging system 1001 receives an adjusted residence time T1′ and/or an adjusted power demand P1′ from the user. It should be noted that the charging system 1001 receives the adjusted residence time T1′ and/or the adjusted power demand P1′ by the input interface 222 or the network module 216.

Next, in the step S716, the output interface 226 displays an allowing message when the charging system can meet the adjusted power demand P1′ and/or the adjusted residence time T1′. For example, when the charging system 1001 receives the adjusted residence time T1′ and the required charging time T3 is less than the adjusted residence time T1′, the output interface 226 displays the allowing message. In another embodiment, when the charging system 1001 receives the adjusted power demand P1′, the charging system 1001 re-calculates an adjusted required charging time according to the adjusted power demand P1′, wherein the output interface 226 displays the allowing message when the adjusted required charging time is less than the residence time T1. In another embodiment, when the charging system 1001 receives an adjusted power demand P1′ and an adjusted residence time T1′, the charging system 1001 re-calculates an adjusted required charging time according to the adjusted power demand P1′, wherein the output interface 226 displays the allowing message when the adjusted required charging time is less than the adjusted residence time T1′. In other words, the output interface 226 displays the allowing message when the charging system 1001 can finish charging the electric vehicle in the residence time T1 or the adjusted residence time T1′ after the adjustment.

In another embodiment, the charging system 1001 can send the allowing message to the handheld device of the user by the network module 216 to notice the user.

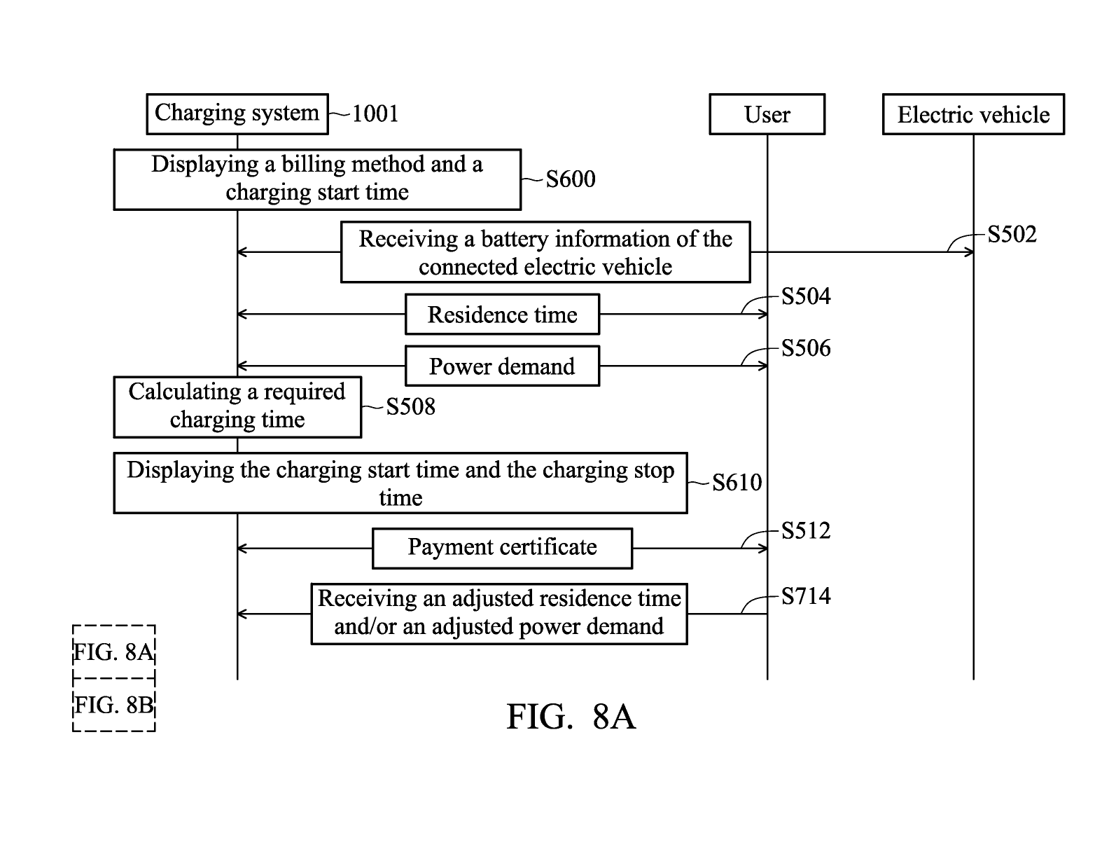

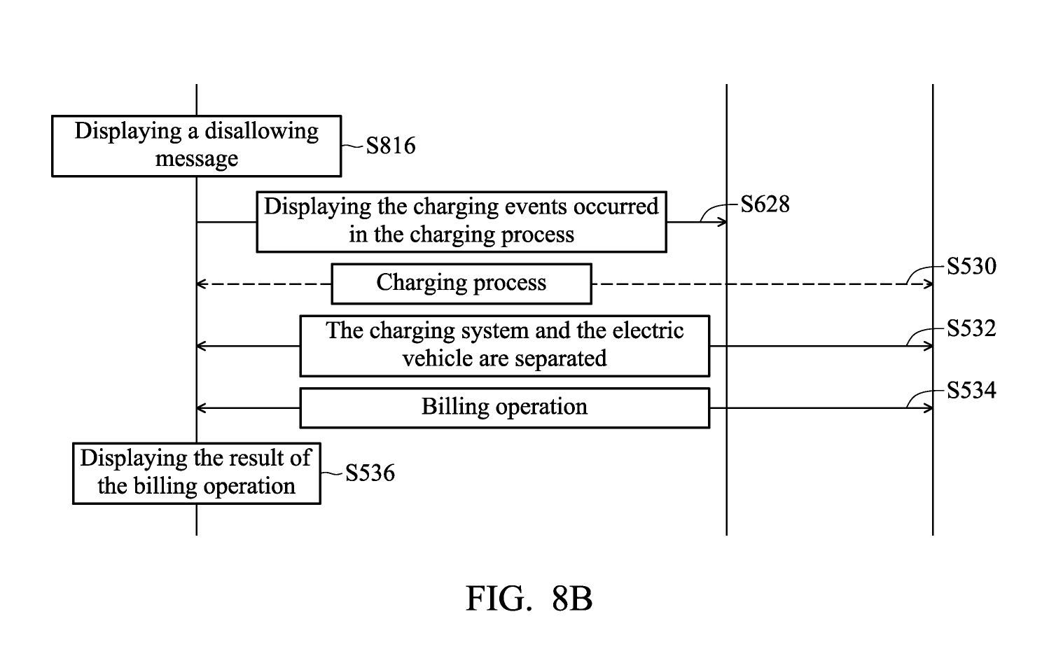

FIGS. 8A-8B are a signal flowchart of a charging management method for electric vehicles according to an exemplary embodiment. The charging management method for electric vehicles is applied to a plurality of charging systems 1001-100N of the electric vehicle management system 100. In this embodiment, the charging system 1001 can not re-execute the dynamic scheduling according to the adjusted residence time T1′ and/or adjusted power demand P1′ during/before the charging process. Furthermore, the charging system 1001 will notice the failure of the dynamic scheduling re-executing to the user. For example, the charging system 1001 determines that the charging process can not meet the adjusted residence time T1′ and/or the adjusted power demand P1′ according to the current scheduling result SR, but it is not limited thereto. The process starts at the step S600. It should be noted that the step S816 is different from the embodiment of FIGS. 7A-7B, but the steps S600, S502-S508, S610, S512, S714, S628, and S530-S536 of this embodiment are similar with the embodiment of FIGS. 7A-7B. Therefore, reference may be made to FIGS. 7A-7B for the details of the steps S600, S502-S508, S610, S512, S714, S628, and S530-S536.

In the step S816, when the charging system 1001 can not meet the adjusted residence time T1′ and/or adjusted power demand P1′, the output interface 226 displays a disallowing message of adjustment. For example, the output interface 226 displays the disallowing message when the charging system 1001 receives an adjusted residence time T1′ and the required charging time T3 is more than the received adjusted residence time T1′. In another embodiment, when the charging system 1001 receives the adjusted power demand P1′, the charging system 1001 re-calculates an adjusted required charging time according to the adjusted power demand P1′, wherein the output interface 226 displays the disallowing message when the adjusted required charging time is more than the residence time T1. In another embodiment, when the charging system 1001 receives an adjusted power demand P1′ and an adjusted residence time T1′, the charging system 1001 re-calculates an adjusted required charging time according to the adjusted power demand P1′, wherein the output interface 226 displays the disallowing message when the adjusted required charging time is more than the adjusted residence time T1′. In another embodiment, the charging system 1001 can send the disallowing message to the handheld device of the user by the network module 216 to notice the user.

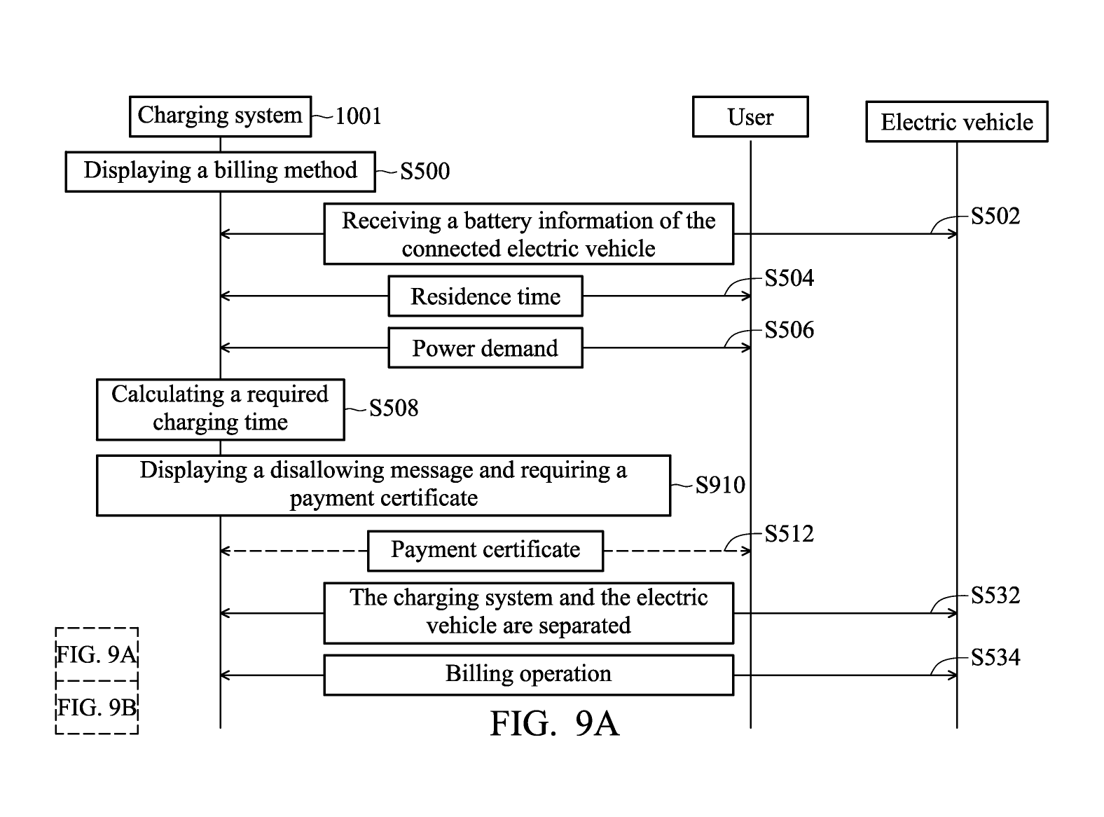

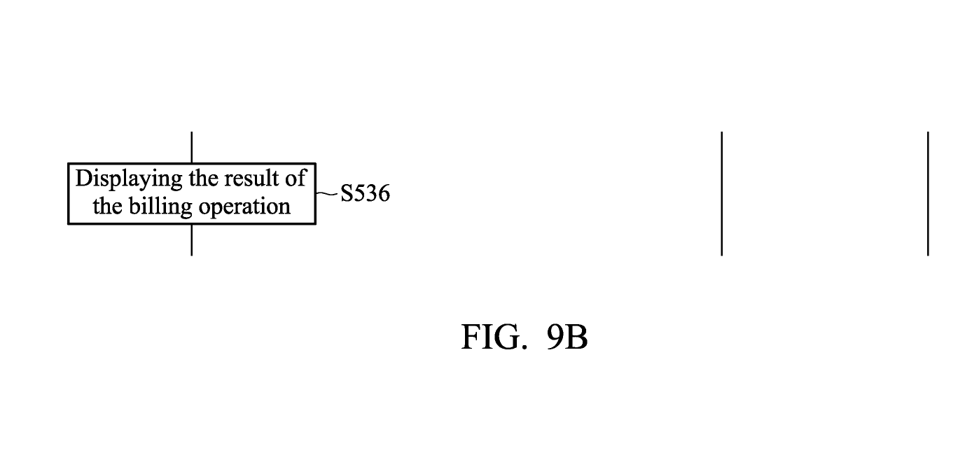

FIG. 9 is a signal flowchart of a charging management method for electric vehicles according to an exemplary embodiment. The charging management method for electric vehicles is applied to a plurality of charging systems 1001-100N of the electric vehicle management system 100. In this embodiment, the charging system 1001 can not finish charging the electric vehicle in the residence time T1. The process starts at the step S500. It should be noted that the step S816 is different from the embodiment of FIG. 5, but the steps S500-S508 of this embodiment are similar with the embodiment of FIG. 5. Therefore, reference may be made to FIG. 5 for the details of the steps S500-S508.

In the step S910, the output interface 226 displays a disallowing message when the required charging time T3 is more than the residence time T1. Furthermore the output interface 226 requires a payment certificate corresponding to the parking fees if the user wants to park without charging. If the user wants to park without charging, the process goes to step S512; otherwise, the process goes to step S534.

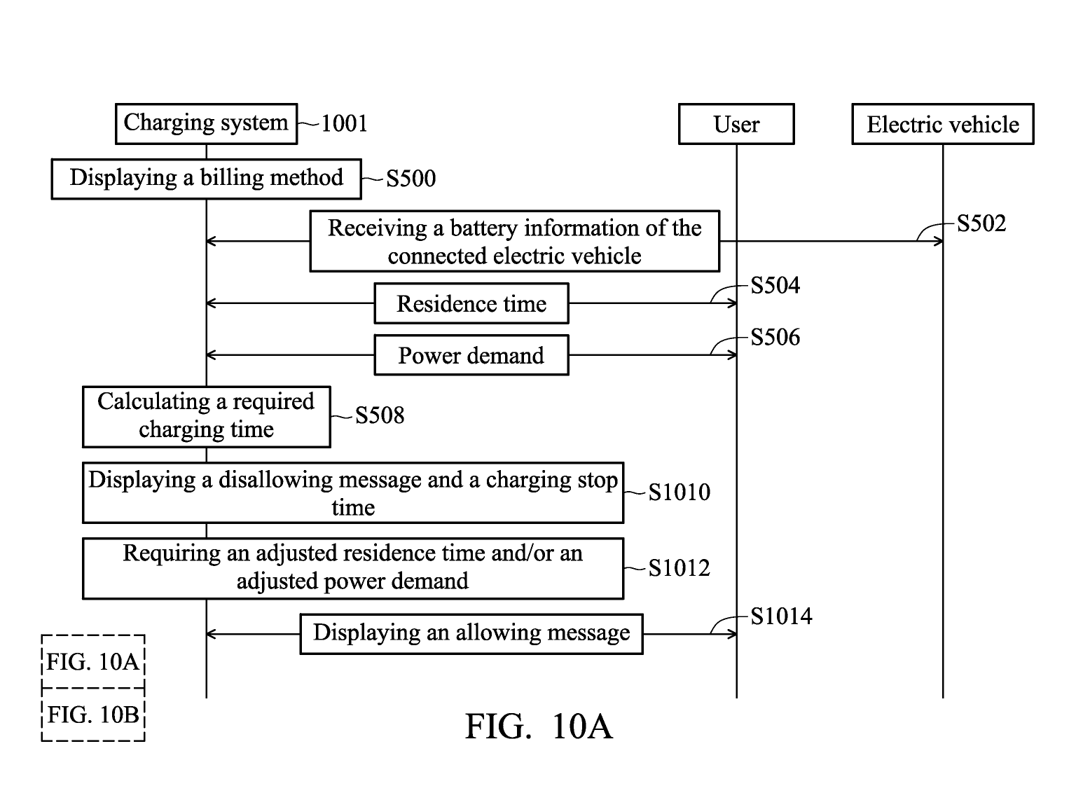

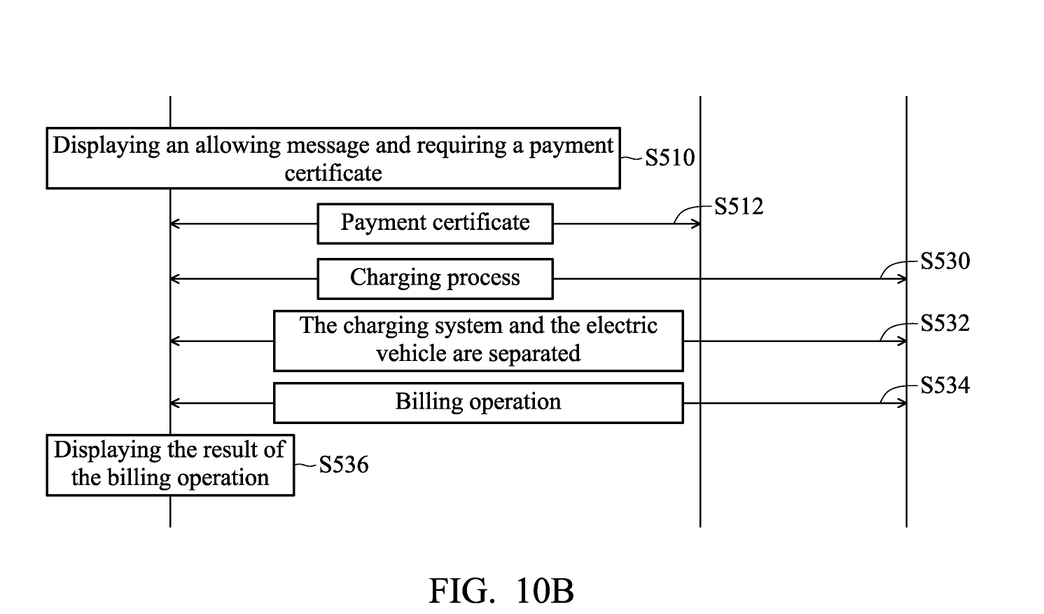

FIGS. 10A-10B are a signal flowchart of a charging management method for electric vehicles according to exemplary embodiments. The charging management method for electric vehicles is applied to a plurality of charging systems 1001-100N of the electric vehicle management system 100. In this embodiment, the charging system 1001 can not finish charging the electric vehicle in the residence time T1, and suggests the user to adjust the power demand P1 and/or residence time T1. The process starts at the step S500. It should be noted that the steps S1010, S1012, and S1014 are different from the embodiment of FIG. 5, but the steps S500-S508, S510-S512, and S530-S536 of this embodiment are similar with the embodiment of FIG. 5. Therefore, reference may be made to FIG. 5 for the details of the steps S500-S508, S510-S512, and S530-S536.

In the step S1010, the output interface 226 displays the disallowing message and a charging stop time when the required charging time T3 is more than the residence time T1, wherein the charging stop time represents when the charging system 1001 can finish charging the electric vehicle.

Next, in the step S1012, the charging system 1001 requires an adjusted residence time T1′ and/or an adjusted power demand P1′ by the output interface 226.

Next, in the step S1014, when the charging system 1001 can finish charging during the adjusted residence time T1′ or the residence time T1, the output interface 226 displays an allowing message. For example, when the user enters an adjusted residence time T1′ at the step S1012, and the required charging time T3 is less than the received adjusted residence time T1′, the output interface 226 displays the allowing message. In another embodiment, when the charging system 1001 receives the adjusted power demand P1′, the charging system 1001 re-calculates an adjusted required charging time according to the adjusted power demand P1′, wherein the output interface 226 displays the allowing message when the adjusted required charging time is less than the residence time T1.

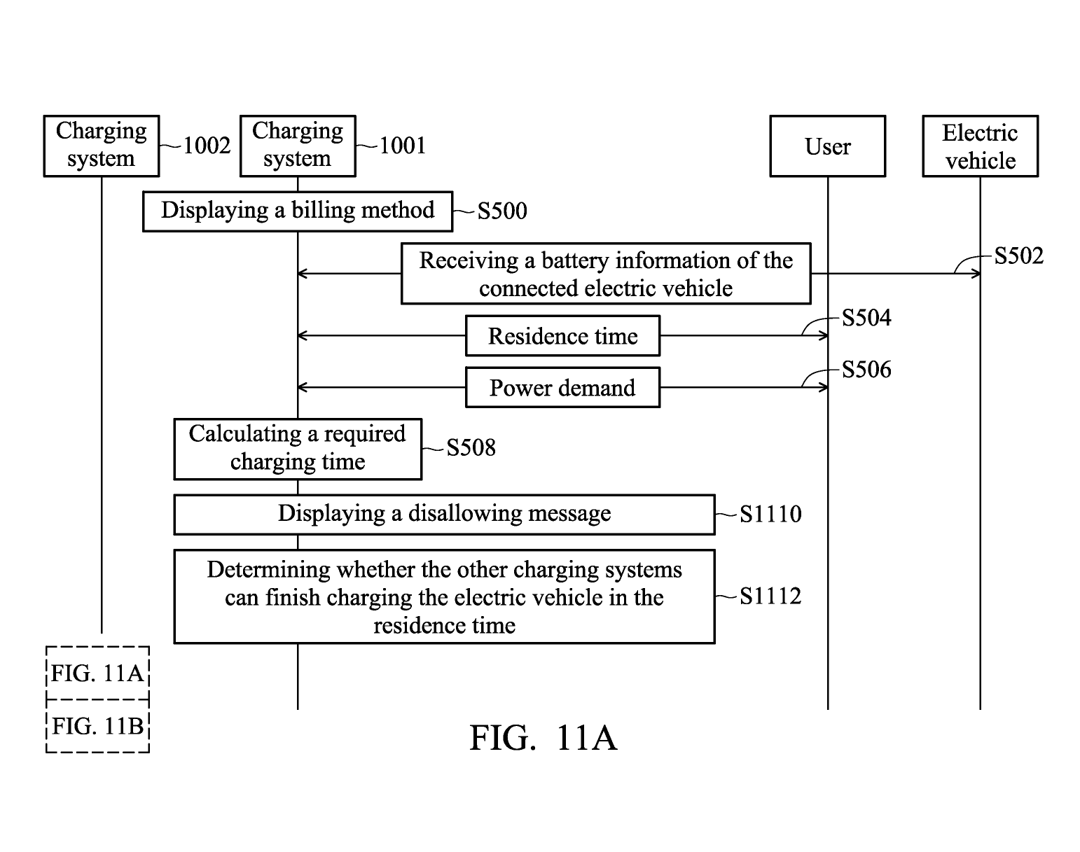

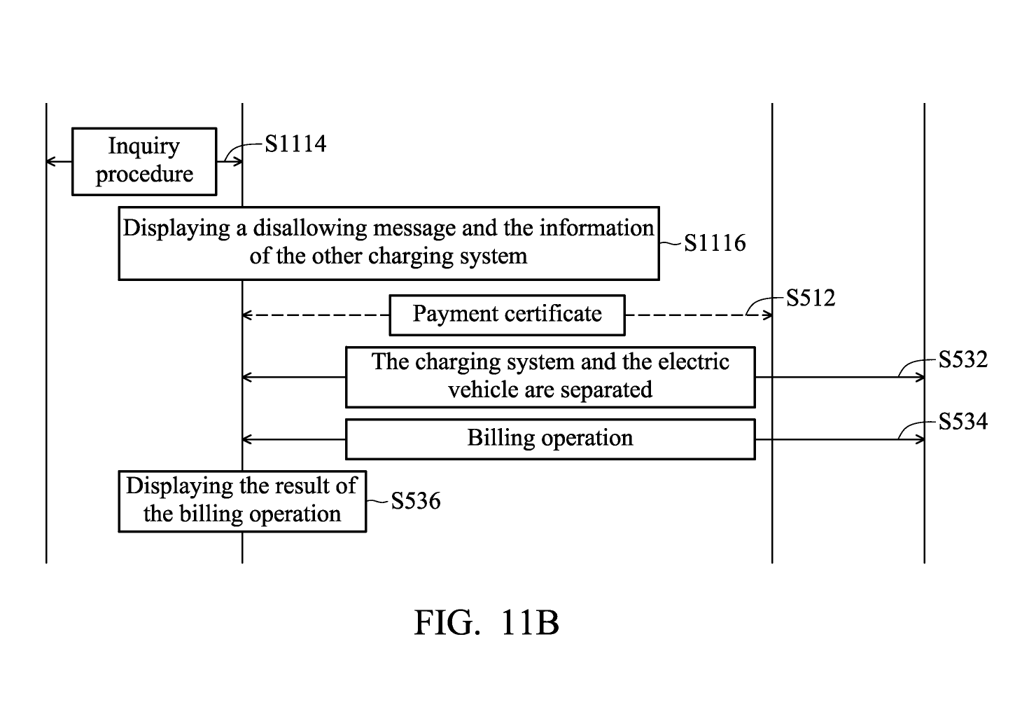

FIGS. 11A-11B are a signal flowchart of a charging management method for electric vehicles according to exemplary embodiments. The charging management method for electric vehicles is applied to a plurality of charging systems 1001-100N of the electric vehicle management system 100. In this embodiment, the charging system 1001 can not finish charging the electric vehicle in the residence time T1, and provides the user the other charging systems 1002-100N which can finish charging the electric vehicle in the residence time T1. The process starts at the step S500. It should be noted that the steps S1110, S1112, S1114, and S1116 are different from the embodiment of FIG. 5, but the steps S500-S508, S512, and S532-S536 of this embodiment are similar with the embodiment of FIG. 5. Therefore, reference may be made to FIG. 5 for the details of the steps S500-S508, S512, and S532-S536.

In the step S1110, the output interface 226 displays a disallowing message when the required charging time P1 is more than the residence time T1.

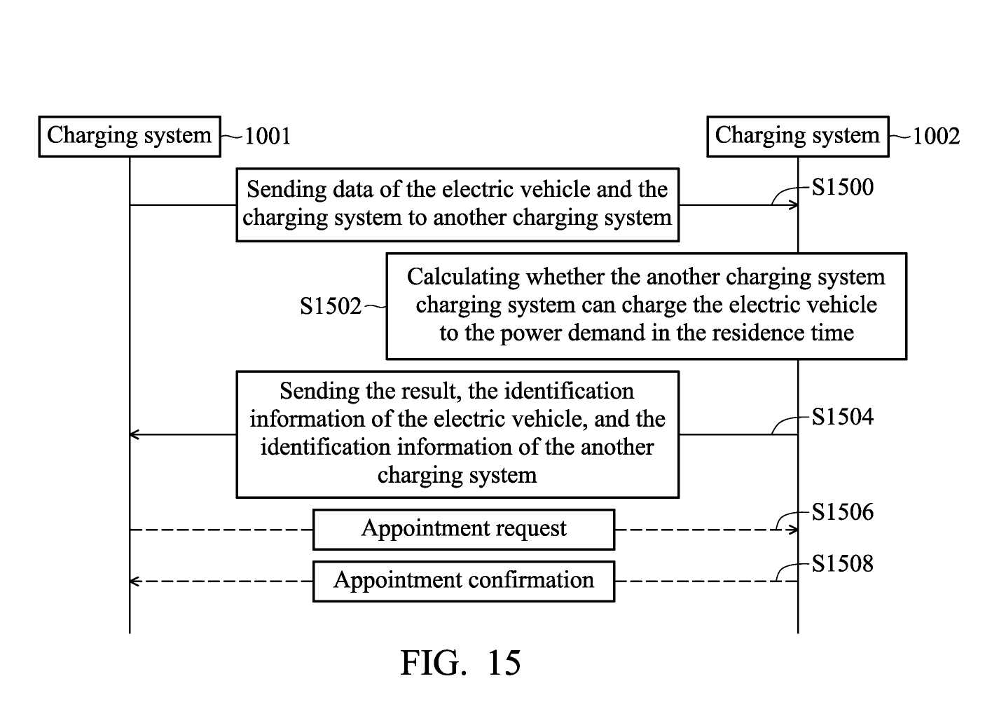

Next, in the step S1112, the charging system 1001 determines whether the other charging systems 1002-100N can finish charging the electric vehicle in the residence time T1 according to the residence time T1 and the power demand P1 of the electric vehicle by an inquiry procedure (step S1114). It should be noted that details of the inquiry procedure will be described with reference to FIG. 15.

Next, in the step S1116, when one of the other charging systems 1002-100N of the charging system (i.e. charging system 1002) can finish charging the electric vehicle in the residence time T1, the output interface 226 of the charging system 1001 displays a disallowing message and the information of the other charging system 1002 that can finish charging during the residence time T1. It should be noted that in another embodiment, the output interface 226 of the charging system 1001 can display the information of a plurality of charging systems 1002-100N which can finish charging the electric vehicle in the residence time T1.

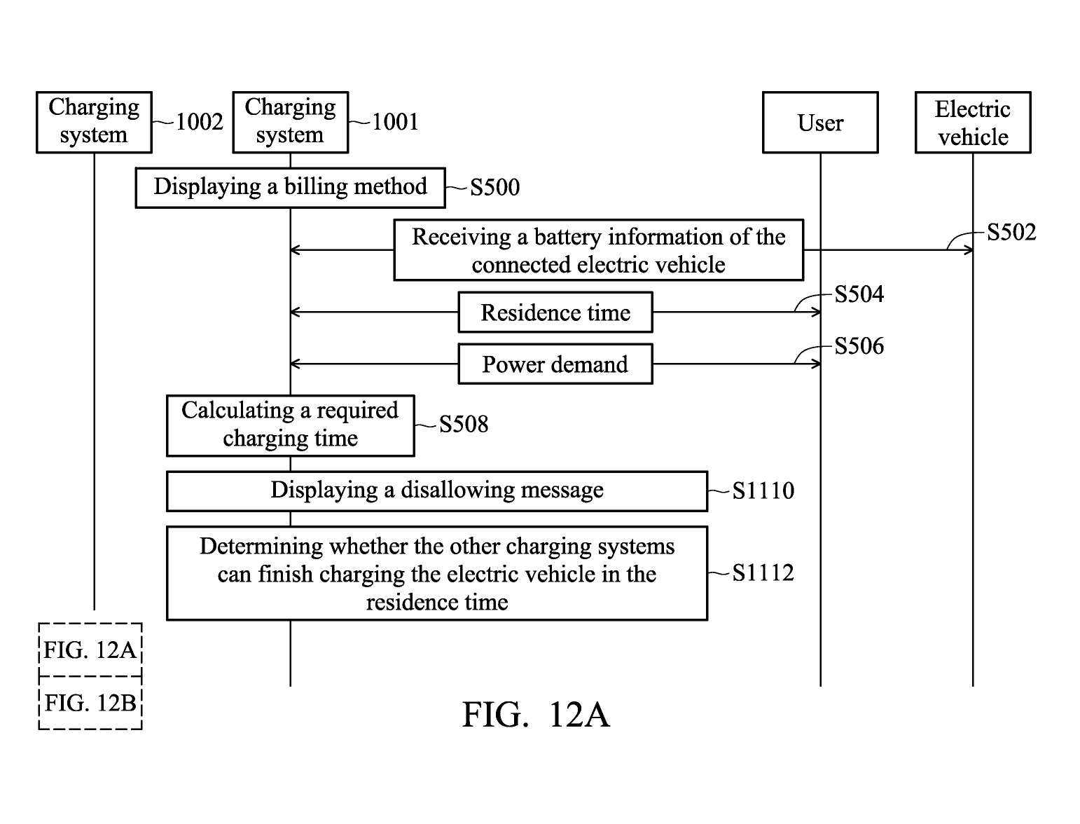

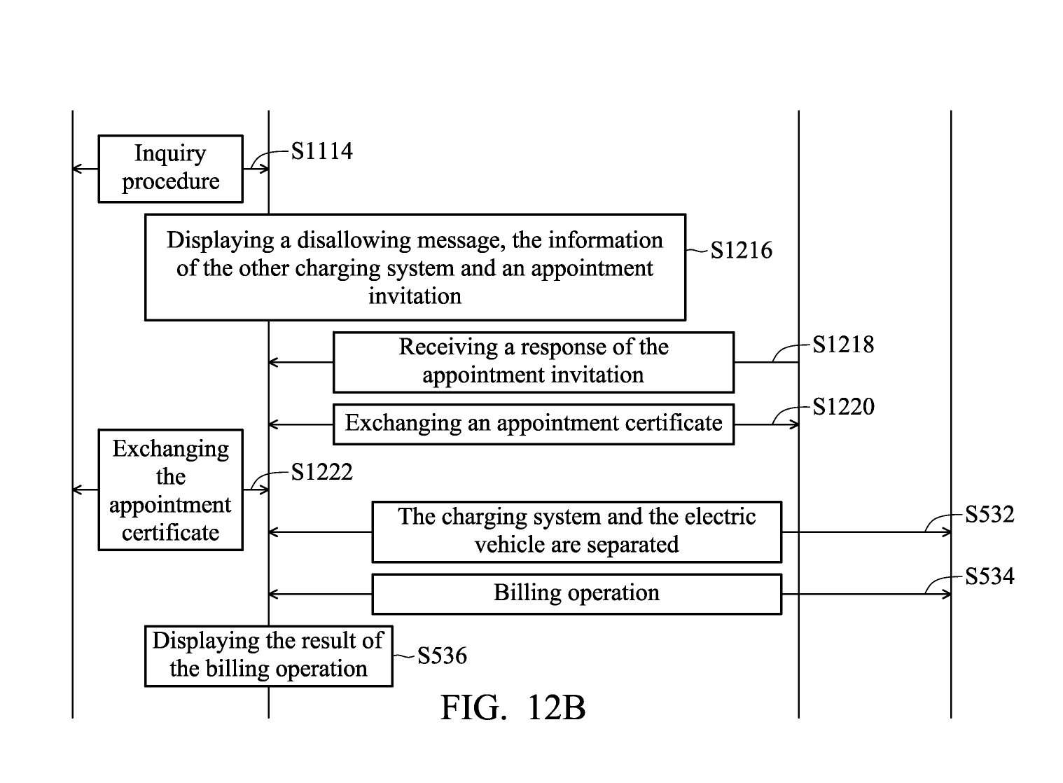

FIGS. 12A-12B are a signal flowchart of a charging management method for electric vehicles according to exemplary embodiments. The charging management method for electric vehicles is applied to a plurality of charging systems 1001-100N of the electric vehicle management system 100. In this embodiment, the charging system 1001 can not finish charging the electric vehicle in the residence time T1, and provides an appointment to the other charging systems 1002-100N which can finish charging the electric vehicle in the residence time T1 for the user. The process starts at the step S500. It should be noted that the steps S1216, S1218, and S1220 are different from the embodiment of FIGS. 10A-10B, but the steps S500-S508, S1110-S1114, and S532-S536 of this embodiment are similar with the embodiment of FIGS. 10A-10B. Therefore, reference may be made to FIGS. 10A-10B for the details of the steps S500-S508, S1110-S1114, and S532-S536.

In the step S1216, when one of the other charging systems 1002-100N (i.e. charging system 1002) can finish charging the electric vehicle in the residence time T1, the output interface 226 of the charging system 1001 displays a disallowing message, the information of the other charging system 1002 that can finish charging during the residence time T1, and an appointment invitation. It should be noted that in another embodiment, the output interface 226 of the charging system 1001 can display the information of a plurality of charging systems 1002-100N which can finish charging the electric vehicle in the residence time T1 and the appointment invitations.

Next, in the step S1218, the charging system 1001 receives a response of the appointment invitation, wherein the response represents that the user wants to make an appointment with the charging system 1002.

Next, in the step S1220, the charging system 1002 exchanges an appointment certificate with the electric vehicle by the inquiry procedure when the charging system 1001 receives the response, wherein the appointment certificate includes identification information of the first charging system, identification information of the electric vehicle, an expected residence time of the electric vehicle, and an expected power demand of the electric vehicle.

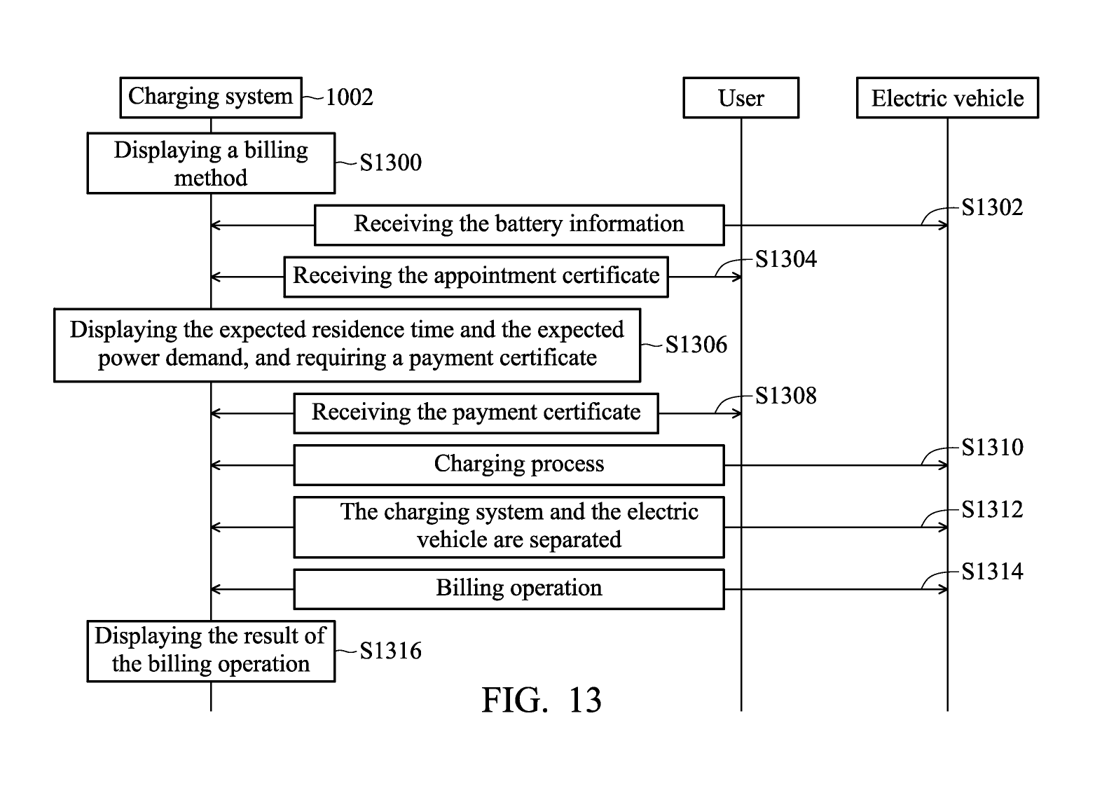

FIG. 13 is a signal flowchart of a charging management method for electric vehicles according to an exemplary embodiment. The charging management method for electric vehicles is applied to a plurality of charging systems 1001-100N of the electric vehicle management system 100. In this embodiment, the charging system 1001 helps the user to make an appointment with the other charging system, and the electric vehicle of the user arrives at the charging system, wherein a prior appointment with the user during an appointment time has been made. For example, the charging system 1001 helps the user to make an appointment with the charging system 1002, and the electric vehicle of user arrives at the charging system 1002 at the appointment time. The process starts at step S1300.

In the step S1300, the charging system 1002 displays a billing method by the output interface 226.

Next, in the step S1302, when the electric vehicle connects to the charging system 1002 during the appointment time, the charging system 1002 receives the battery information B1 of the electric vehicle. In the step S1304, the charging system 1002 receives the appointment certificate of the electric vehicle.

Next, in the step S1306, the charging system 1002 displays the expected residence time and the expected power demand of the electric vehicle, and requires a payment certificate corresponding to the charging fees.

Next, in the step S1308, the charging system 1002 receives the payment certificate. In the step S1310, the charging system 1002 executes a charging process according to the expected residence time and the expected power demand. It should be noted that for details of the charging process, reference may be made to the description of FIG. 5.

Next, in the step S1312, the electric vehicle and the charging system 1002 are separated. In the step S1314, the charging system 1002 executes a billing operation according to the time period of the connection between the electric vehicle and the charging system 1002, the queue-jumping request, and the dynamic scheduling. In the step S1316, the charging system 1002 displays the result of the billing operation. It should be noted that, the result of the billing operation is proportional to the period of the connection between the electric vehicle and the charging system 1002. In another embodiment, if the queue of the electric vehicle is jumped by the other electric vehicles during the charging process, the result of the billing operation will be decreased. In another embodiment, if the electric vehicle jumps the queue during the charging process, the result of the billing operation will be increased.

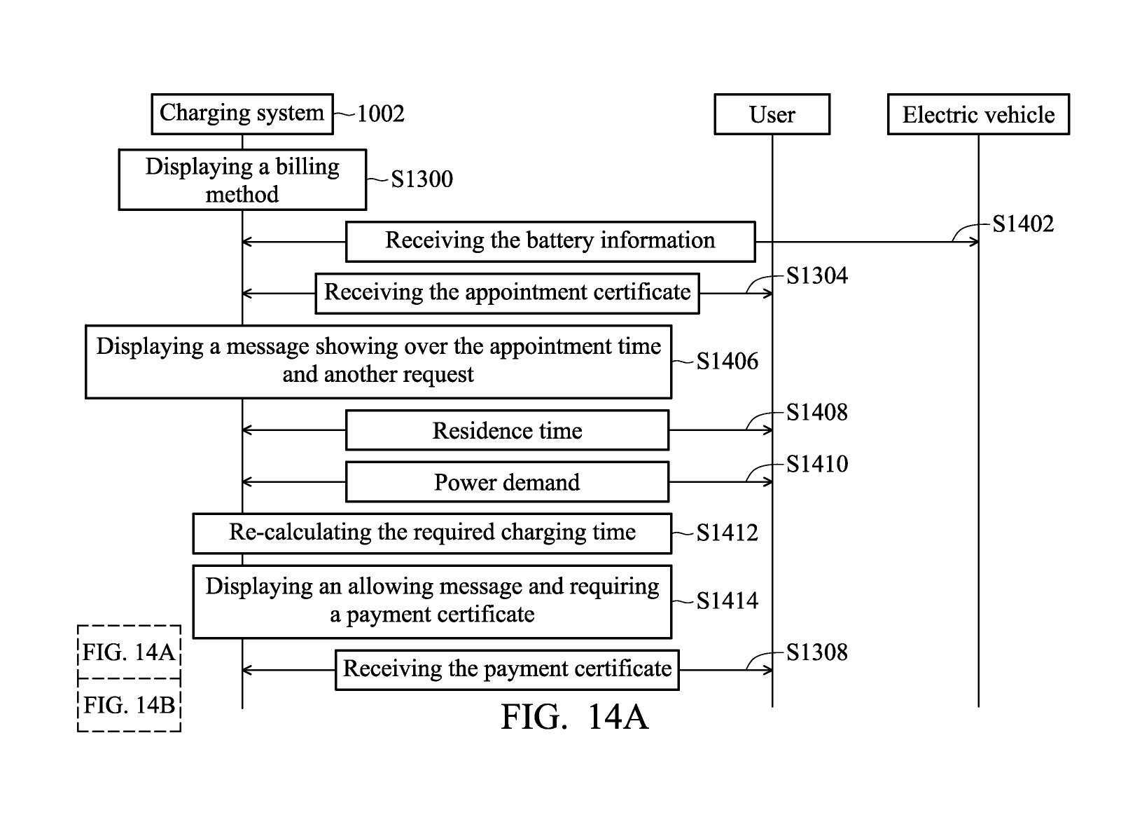

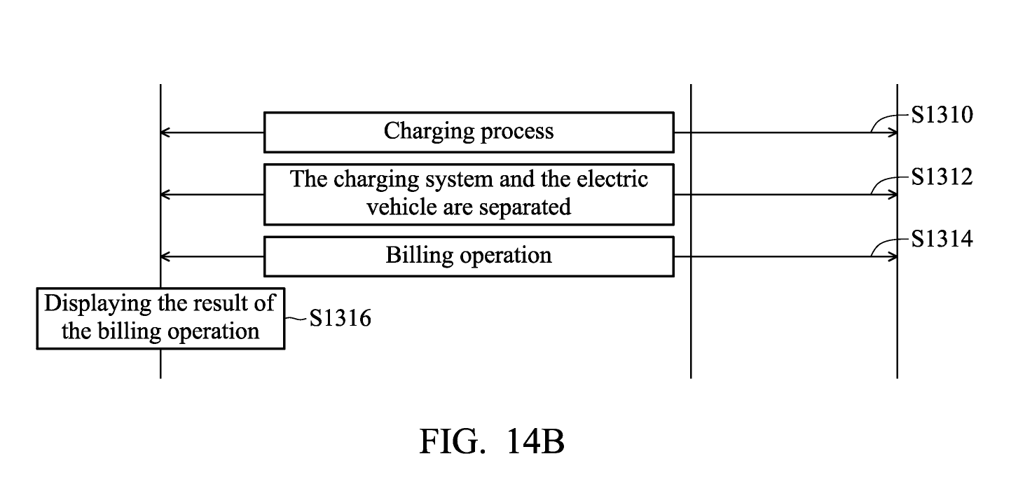

FIGS. 14A-14B are a signal flowchart of a charging management method for electric vehicles according to an exemplary embodiment. The charging management method for electric vehicles is applied to a plurality of charging systems 1001-100N of the electric vehicle management system 100. In this embodiment, the charging system 1001 makes an appointment with one of the charging systems 1002-100N for the user, and the electric vehicle of the user arrives at the charging system which has made an appointment with the user over an appointment time between the user and the charging system. For example, the charging system 1001 made an appointment with the charging system 1002 for the user, and the electric vehicle of the user arrives at the charging system 1002 over the appointment time. The process starts at the step S1300. It should be noted that the steps S1402˜S1414 are different from the embodiment of FIG. 13, but the steps S1300, S1304, and S1310-S1316 of this embodiment are similar with the embodiment of FIG. 13. Therefore, reference may be made to FIG. 13 for the details of the steps S1300, S1304, and S1310-S1316.

In the step S1402, the connection time of the charging system 1002 and the electric vehicle is not in the appointment time, and receives the battery information B1 of the electric vehicle.

Next, in the step S1406, the charging system 1002 displays a message showing that the connection time of the charging system 1002 and the electric vehicle is not in the appointment time and another message requiring re-entering of the request.

Next, in the step S1408, the charging system 1002 receives the new residence time T1 again. In the step S1410, the charging system 1002 receives the new power demand P1 again.

Next, in the step S1412, the charging system 1002 re-calculates the required charging time T3 according to the new battery information B1 and the new power demand P1.

Next, in the step S1414, when the required charging time T3 re-calculated by the charging system 1002 is less than the residence time T1, the charging system 1002 displays an allowing message and requires a payment certificate corresponding to the charging fees.

FIG. 15 is a signal flowchart of a charging management method for electric vehicles according to an exemplary embodiment. The charging management method for electric vehicles is applied to an inquiry procedure of a plurality of charging systems 1001-100N of the electric vehicle management system 100, wherein each of the charging systems 1001-100N charges a plurality of electric vehicles. The following description takes the charging systems 1001 and 1002 as the example, and the process starts at the step S1500.

In the step S1500, the charging system 1001 sends data of the electric vehicle connected to the charging system 1001 and the charging system 1001 to the charging system 1002, wherein the data includes identification information, a charging start time, a residence time T1, battery information B1, and a power demand P1 of the electric vehicle. In another embodiment, the charging start time sent by the charging system 1001 can also be the time that the user expects to arrive at the charging system 1002, and the residence time T1 can also be the time that the user expects to leave the charging system 1002.

Next, in the step S1502, the charging system 1002 calculates whether the charging system 1002 can charge the electric vehicle to the power demand P1 in the residence time T1, and produces a result.

Next, in the step S1504, the charging system 1002 sends the result produced at the step 1502, the identification information of the electric vehicle, and the identification information of the charging system 1002 to the charging system 1001.

Next, in the step S1506, the charging system 1001 sends an appointment request to the charging system 1002 when the result produced at the step 1502 represents that the charging system 1002 can meet the residence time T1 and the power demand P1. The appointment request includes the identification information of the electric vehicle and an appointment certificate, wherein the appointment certificate includes the identification information, an expected residence time, and an expected power demand of the electric vehicles.

Next, in the step S1508, when the charging system 1002 receives the appointment request, the charging system 1002 sends an appointment confirmation to the charging system 1001, wherein the appointment confirmation includes identification information and an appointment certificate of the charging system 1002.

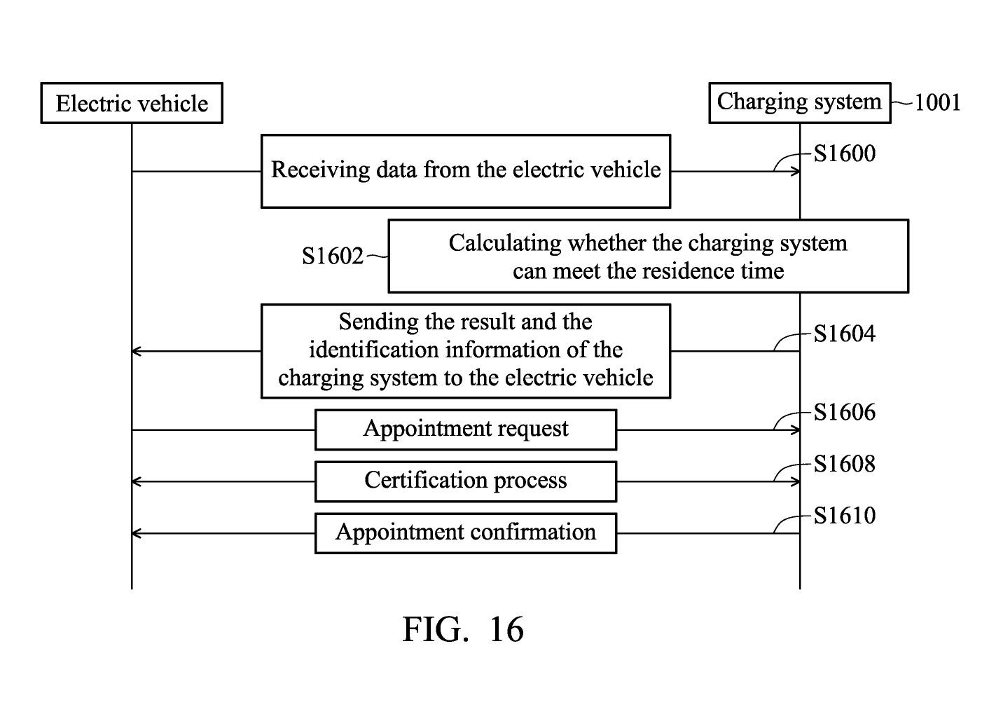

FIG. 16 is a signal flowchart of a charging management method for electric vehicles according to an exemplary embodiment. The charging management method for electric vehicles is applied to an electric vehicle connected to the charging systems 1001-100N by a network. The following description takes the charging system 1001 as the example, and the process starts at the step S1600.

In the step S1600, the charging system 1001 receives data from the electric vehicle, wherein the data includes identification information of the electric vehicle, a payment certificate, a charging start time, a residence time T1, battery information B1, and a power demand P1.

Next, in the step S1602, the charging system 1001 calculates whether the charging system 1001 can meet the residence time T1 and the power demand P1 according to the data received at the step S1600, and produces a result.

Next, in the step S1604, the charging system 1001 sends the result produced at the step S1602 and the identification information of the charging system 1001 to the electric vehicle.

Next, in the step 1606, the charging system 1001 receives an appointment request from the electric vehicle when the result produced at the step S1602 represents that the charging system 1001 can meet the residence time T1 and the power demand P1, wherein the appointment request includes the identification information and the payment certificate of the electric vehicle.

Next, in the step S1608, the charging system 1001 executes a certification process according to the identification information and the payment certificate of the electric vehicle.

Next, in the step S1610, the charging system 1001 sends an appointment confirmation to the electric vehicle, wherein the appointment confirmation includes identification information and an appointment certificate of the charging system 1001. The process ends at the step S1610.

The embodiments of the electric vehicle management system 100 recharges the electric vehicles by A multiple recharging system, such that the electric vehicle management system 100 will not be occupied by electric vehicles which is still connected to the system and finished the charging process. If the electric vehicle management system 100 is occupied by electric vehicles which is finished the charging process, the electric vehicle management system 100 will not be able to charge the other electric vehicles due to the idling of the processor in the electric vehicle management system 100. In addition, the present embodiments implement the management device 210 with a one-to-many or multiple charging device to control the starting and stopping time of the electric vehicle and charge the electric vehicle sequentially according to the dynamic scheduling result.

Data transmission methods, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the exemplary embodiments have been described by way of example and in terms of the preferred embodiments, it is to be understood that the exemplary embodiments are not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A charging system, comprising:
a management device, comprising:
a scheduling control module, configured to execute dynamic scheduling according to a residence time and a charging time, and re-execute the dynamic scheduling according to a queue-jumping request; and
a charging host, configured to calculate the charging time according to battery information, and charge a plurality of electric vehicles according to the dynamic scheduling; and
a plurality of charging devices, coupled to the management device, wherein each of the charging devices comprises:
an input interface, configured to receive the residence time and a power demand; and
a charging plug, connected to one of the electric vehicles to receive the battery information, and charge the connected electric vehicle.

2. The charging system as claimed in claim 1, wherein the scheduling control module further comprises:
a storage device, configured to store a current scheduling result according to the dynamic scheduling, wherein the current scheduling result comprises a charging plan of each of the connected electric vehicles scheduled by the dynamic scheduling;
a charging-time estimation module, configured to calculate a required charging time according to the charging time and a power demand;
a control module, configured to determine whether the electric vehicles need to jump the queue of the dynamic scheduling according to the residence time, the required charging time, and the current scheduling result;
a scheduling calculation module, configured to execute a scheduling calculation according to the required charging time, the residence time, and the current scheduling result when the electric vehicles do not need to jump the queue of the dynamic scheduling, and update the current scheduling result of the storage device according to the scheduling calculation; and
a queue-jumping module, configured to determine whether the current scheduling result has a time point which is allowed to jump the queue when one of the electric vehicles need to jump the queue of the dynamic scheduling, wherein the queue-jumping module produces the queue-jumping request and executes a queue-jumping calculation according to the time point, required charging time, residence time, and the current scheduling result when the current scheduling result has the time point, and updates the current scheduling result of the storage device according to the queue-jumping calculation.

3. The charging system as claimed in claim 1, wherein the management device further comprises a first network module configured to send related events occurred in the scheduling control module to a handheld device, and receive an adjusted residence time and an adjusted power demand from the handheld device, wherein the scheduling control module re-executes the dynamic scheduling according to the adjusted residence time and the adjusted power demand.

4. The charging system as claimed in claim 2, wherein each of the charging devices further comprises an output interface configured to display the other charging system with a lower loading than the charging system with a output interface when the current scheduling result does not have the time point.

5. The charging system as claimed in claim 1, wherein each of the charging devices further comprises a second network module configured to execute a payment process.

6. The charging system as claimed in claim 1, wherein the battery information comprises a battery type and remaining power of the electric vehicle.

7. The charging system as claimed in claim 2, wherein the scheduling control module further comprises:
a billing module, configured to execute a billing operation according to the time period of the connection between the electric vehicle and the charging plug, the queue-jumping request, and the dynamic scheduling when the connected electric vehicle and the charging plug are separated; and
an authentication module, configured to certify a smart card or a credit card according to the billing operation.

8. A charging management method for electric vehicles, applied to a plurality of charging systems of an electric vehicle management system, wherein each of the charging systems charges a plurality of electric vehicles, the charging management method for electric vehicles comprising:
receiving battery information, a residence time, and a power demand from a first electric vehicle of the electric vehicles, when the first electric vehicle connects to a charging plug;
calculating a required charging time according to the battery information and the power demand;
executing a charging process when the required charging time is less than the residence time, wherein the charging process comprises:
executing dynamic scheduling according to the residence time and the required charging time;
re-executing the dynamic scheduling according to a queue-jumping request, when the queue-jumping request is received; and
charging the first electric vehicle according to the dynamic scheduling; and
executing a billing operation according to the time period of the connection between the first electric vehicle and the charging system, the queue-jumping request, and the dynamic scheduling, when the first electric vehicle and the charging system are separated.

9. The charging management method for electric vehicles as claimed in claim 8, when the required charging time is less than the residence time, further comprising:
displaying a charging start time and a charging stop time, wherein the charging start time represents when the charging system will start to charge the first electric vehicle and the charging stop time represents when the charging system will finish charging the first electric vehicle; and
displaying charging events occurring in the charging process.

10. The charging management method for electric vehicles as claimed in claim 8, wherein the charging process further comprises:
receiving an adjusted residence time or an adjusted power demand;
displaying an allowing message when the charging system has met the adjusted residence time or the adjusted power demand; and
displaying a disallowing message when the charging system has not met the adjusted residence time or the adjusted power demand.

11. The charging management method for electric vehicles as claimed in claim 8, further comprising displaying a disallowing message when the required charging time is more than the residence time.

12. The charging management method for electric vehicles as claimed in claim 8, when the required charging time is more than the residence time, further comprising:
displaying a disallowing message and a charging stop time, wherein the charging stop time represents when the charging system will finishes charging the first electric vehicle
requiring an adjusted residence time or an adjusted power demand;
displaying an allowing message when the required charging time is less than the required adjusted residence time; and
re-calculating an adjusted required charging time after receiving the adjusted power demand, and displaying the allowing message when the adjusted required charging time is less than the residence time.

13. The charging management method for electric vehicles as claimed in claim 8, when the required charging time is more than the residence time, further comprising:
determining whether the other charging systems of the electric vehicle management system will finishes charging the first electric vehicle in the residence time according to the residence time and the power demand of the first electric vehicle by an inquiry procedure; and
displaying a disallowing message and information of a first charging system of the other charging systems when the first charging system will finish charging the first electric vehicle in the residence time.

14. The charging management method for electric vehicles as claimed in claim 13, when the first charging system has met the residence time, further comprising, exchanging an appointment certificate between the first charging system and the first electric vehicle by the inquiry procedure when receiving an agreement corresponding to executing the appointment, wherein the appointment certificate comprises identification information of the first charging system, identification information of the first electric vehicle, an expected residence time of the first electric vehicle, and an expected power demand of the first electric vehicle.

15. The charging management method for electric vehicles as claimed in claim 14, further comprising:
receiving the battery information and the appointment certificate of the first electric vehicle when the first charging system and the first electric vehicle are connected during an appointment time, and sending the battery information and the appointment certificate of the first electric vehicle to the first charging system;
executing the charging process according to the expected residence time and the expected power demand by the first charging system; and
executing the billing operation according to the time period of the connection between the first electric vehicle and the charging system, the queue-jumping request, and the dynamic scheduling, when the first electric vehicle and the first charging system are separated.

16. The charging management method for electric vehicles as claimed in claim 14, further comprising:
receiving the battery information and the appointment certificate of the first electric vehicle when the first charging system and the first electric vehicle are not connected during an appointment time, and sending the battery information and the appointment certificate of the first electric vehicle to the first charging system;
displaying a re-enter request by the first charging system;
re-receiving the battery information and the appointment certificate of the first electric vehicle, and the power demand by the first charging system;
calculating the required charging time according to the battery information and the power demand by the first charging system:
executing the charging process according to the required charging time by the first charging system; and
executing the billing operation according to the queue-jumping request, the dynamic scheduling, and period of the connection between the first electric vehicle and the charging system when the first electric vehicle and the charging system are separated.

17. A charging management method for electric vehicles, comprising:
sending data of an electric vehicle connected to a first charging system to a second charging system, wherein the data comprises identification information, a charging start time, a residence time, battery information, and a power demand of the electric vehicle;
calculating whether the second charging system has met the power demand in the residence time according to the data, and producing a result;
sending the result to the first charging system;
sending an appointment request to the second charging system by the first charging system when the result represents that the second charging system has met the power demand in the residence time, wherein the appointment request comprises identification information and an appointment certificate of the electric vehicle, and the appointment certificate comprises identification information, an expected residence time, and an expected power demand of the electric vehicle; and;
sending an appointment confirmation to the second charging system from the first charging system when the second charging system receives the appointment request, wherein the appointment confirmation comprises identification information and an appointment certificate of the second charging system.

18. A charging management method for electric vehicles, comprising:
receiving data from an electric vehicle, wherein the data comprises identification information, a payment certificate, a charging start time, a residence time, battery information, and a power demand of the electric vehicle;
calculating whether the charging system has met the power demand in the residence time according to the data, and producing a result;
sending the result to the electric vehicle;
receiving an appointment request of the electric vehicle when the result represents that the charging system has met the power demand in the residence time, wherein the appointment request comprises the identification information and the payment certificate;
executing a certification process according to the identification information and the payment certificate; and
sending an appointment confirmation to the electric vehicle, wherein the appointment confirmation comprises identification information of the charging system.
